(19) United States
(12) Patent Application Publication
(10) Pub. No.: US 2025/0196436 A1
(43) Pub. Date: Jun. 19, 2025

(54) SYSTEMS AND METHODS FOR ADDITIVE MANUFACTURE EXTRUSION DIVERTER VALVE AND SENSOR ASSEMBLY

(71) Applicant: Lawrence Livermore National Security, LLC, Livermore, CA (US)

(72) Inventors: Siddharthan SELVASEKAR, Livermore, CA (US); August Samuel HONNELL, Walnut Creek, CA (US); Benjamin Michael PATMON, Dublin, CA (US); Stephen KOCH, North Highlands, CA (US); Parker MOBERG, Dublin, CA (US); Hamed Ziad AMMAR, Oakland, CA (US)

(21) Appl. No.: 18/542,427

(22) Filed: Dec. 15, 2023

(51) Int. Cl. B29C 64/209; B29C 64/106; B33Y 10/00; B33Y 30/00

(52) U.S. Cl. CPC B29C 64/209; B29C 64/106; B33Y 10/00; B33Y 30/00

(57) ABSTRACT

The present disclosure relates to an apparatus for extruding material to make a part using a flowable feedstock printing material. In one embodiment the apparatus makes use of a controller and a print nozzle system. The print nozzle system includes a nozzle housing for receiving the flowable feedstock material, and a nozzle element from which the flowable feedstock material is extruded. A valve system is included which communicates with the controller for controllably interrupting and restarting a flow of the flowable feed during a print operation.

### FEDERALLY SPONSORED RESEARCH OR DEVELOPMENT

This invention was made with Government support under Contract No. DE-AC52-07NA27344 awarded by the United States Department of Energy. The Government has certain rights in the invention.

### FIELD

The present disclosure relates to systems and methods for extruding a feedstock material to make a part or structure, and more particularly to systems and methods for controllably interrupting a flow of the feedstock material from an extrusion nozzle as needed during a printing or manufacturing process.

### BACKGROUND

The statements in this section merely provide background information related to the present disclosure and may not constitute prior art.

Present day displacement based Direct Ink Write (DIW) systems do not have the ability to start and stop ink flow freely without passive flow (leakage) from the nozzle. Methods of blocking the flow or stopping displacement from the nozzle tip deviate the process from steady state flow. To achieve a steady state flow from the nozzle, a purge step is usually needed prior to starting the print. The purge is held until the flow achieves a constant response from response force transducers in the dispensing system. Maintaining steady state flow is an issue not only in DIW systems, but also for large diameter material extrusion processes (such as Big Area Additive Manufacturing (“BAAM”) and concrete printing), and frequently for extrusion processes. This steady state flow limitation thus prevents complex geometries from being built; that is, the DIW and BAAM processes are currently restrained to geometries that are continuous (e.g., toolpaths that are analogous to a pencil never leaving a paper when drawing).

Accordingly, there is still a need for systems and methods for use with DIW and other extrusion systems which remedy the limitations associated with passive flow leakage from an extrusion print head or extrusion-like nozzle component.

### SUMMARY

This section provides a general summary of the disclosure, and is not a comprehensive disclosure of its full scope or all of its features.

In one aspect the present disclosure relates to an apparatus for extruding material to make a part using a flowable feedstock material. The apparatus may comprise a controller and a print nozzle. The print nozzle may include a nozzle housing for receiving the flowable feedstock material, and a nozzle element from which the flowable feedstock material is extruded. The print nozzle may also include a valve system responsive to the controller for controllably interrupting and restarting a flow of the flowable feedstock material during a print operation.

In another aspect the present disclosure relates to a print nozzle system including a nozzle housing for receiving a flowable feedstock material, and a nozzle element. The nozzle element is in communication with the nozzle housing from which the flowable feedstock material is extruded. The print nozzle system further includes a valve system responsive to the controller for controllably interrupting and restarting a flow of the flowable feedstock material during a print operation. The valve system is configured relative to the nozzle housing and the nozzle element to divert a portion of the feedstock material flowing through the housing toward the nozzle element when a flow of the feedstock material is to be interrupted, and to block the flow of a remaining portion of the feedstock material upstream of the nozzle element from flowing through the nozzle element.

In still another aspect the present disclosure relates to a print nozzle system. The print nozzle system may include a nozzle housing for receiving a flowable feedstock material. A nozzle element is also included which is in communication with the nozzle housing from which the flowable feedstock material is extruded. A valve system is included for controllably interrupting and restarting a flow of the flowable feedstock material during a print operation. The valve system is configured relative to the nozzle housing and the nozzle element to divert a portion of the feedstock material flowing through the housing toward the nozzle element when a flow of the feedstock material is to be interrupted, and to block the flow of a remaining portion of the feedstock material upstream of the nozzle element from flowing through the nozzle element.

In still another aspect the present disclosure relates to a method for extruding material to make a part using a flowable feedstock material. The method may comprise causing a flowable feedstock material to flow into a housing and to be used to print a part on a build table. When a flow of the feedstock material is to be temporarily interrupted, then several operations may be performed. Initially, a first valve may be used to divert at least a first portion of the feedstock material flowing through the housing out from the housing. A second valve may be used which is configured downstream of the first valve, relative to a direction of flow of the feedstock material through the housing. The second valve may be used to block an additional portion of the feedstock flow from reaching a nozzle element and being extruded out from the nozzle element.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

Corresponding reference numerals indicate corresponding parts throughout the several views of the drawings.

FIG. 1 is a perspective view of one embodiment of an extrusion feed nozzle system in accordance with the present disclosure;

FIG. 2 is an exploded perspective view of the system of FIG. 1;

FIG. 3 is a view of another embodiment of a nozzle valve in accordance with the present disclosure, where the nozzle valve incorporates an additional port for housing an additional sensor;

FIG. 4 is a high level cross-sectional side view of the nozzle valve of FIG. 1;

FIG. 5 is a high level cross-sectional side view of the diverter valve of FIG. 1;

FIG. 5a is a high level cross-sectional side view of a valve system in accordance with the present disclosure, where the valve system has the exhaust/diverter and nozzle valves integrated into a single housing; and

FIG. 6 is a high level flowchart of operations that may be performed in initially calibrating the system of FIG. 1 for use.

### DETAILED DESCRIPTION

Example embodiments will now be described more fully with reference to the accompanying drawings.

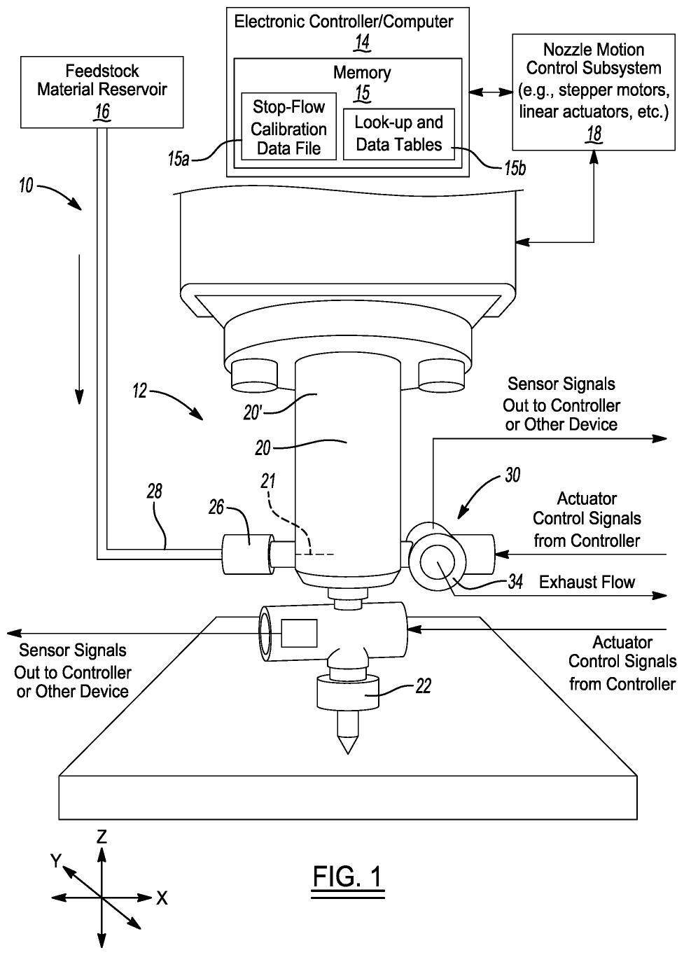

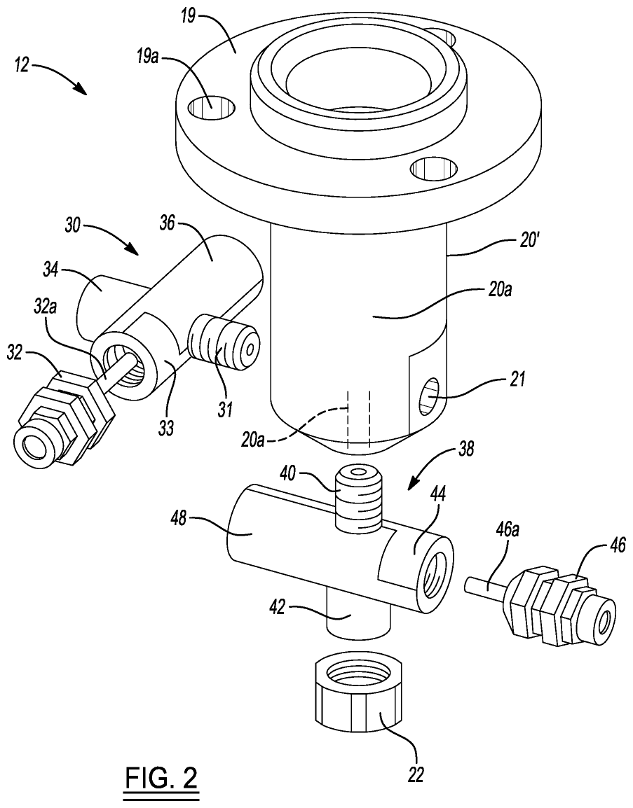

Referring now to FIGS. 1 and 2, an extrusion system 10 is shown in accordance with one embodiment of the present disclosure. With specific reference to FIG. 1, in this example the system 10 includes a nozzle assembly 12, an electronic controller/computer 14 (hereinafter simply “controller” 14), a memory 14a (e.g., non-volatile RAM/ROM/EPROM/EEPROM/DRAM, etc.) for storing a stop-flow calibration data file 15a and a file containing look-up tables and data tables for printing with different types of feedstock materials. A feedstock material reservoir 16 may be included for holding a quantity of feedstock material to be used in printing, and a nozzle motion control subsystem 18 may be included for controlling motion of the nozzle assembly 12. In some embodiments the nozzle motion control subsystem 18 controls motion of the nozzle assembly 12 along the X/Y plane, and in some embodiments controls motion with the X/Y plane as well as within the Z plane. The nozzle motion control subsystem 18 in some embodiments makes use of DC stepper motors. In some embodiments linear actuators are used, and in some embodiments a combination of DC stepper motors and linear actuators are used. The nozzle motion control subsystem 18 is not limited to use of DC stepper motors and/or linear actuators, and any other components suitable for controlling motion of the nozzle assembly 12 in the X, Y and/or Z planes may be used.

The print nozzle assembly 12 includes a housing 20′ for receiving and mixing ink, which forms a component of the material extruded from the nozzle assembly 12. The housing 20′ has a mixing portion 20 where ink can be mixed with other feedstock components, and an annular portion 19 with apertures 19a for external fastening components (e.g., threaded bolts, not shown) that can be used to fasten the nozzle assembly 12 to other structure of the system 10. Such other structure may be any suitable rigid hardware attached to a desired linear stage/axis. The annular portion 19 could also be mounted to any suitably rigid, stationary hardware and then print could be carried out on a substrate (e.g., build table) that is supported on a linear stage.

The nozzle assembly 12 also includes a nozzle element 22 where the feedstock material is extruded onto a build table 24. In this example the nozzle assembly 12 further includes a feed fitting 26 which may be coupled to a feed conduit 28 to feed feedstock material 16 into the mixing portion 20 via an internal feed flow path 21. A diverter valve 30 is coupled to the mixing portion 20. As is visible in FIG. 2, the diverter valve 30 may be formed from metal aluminum or any other suitable material, and may include an input port 31, a diverter actuator 32 coupled to an actuator housing portion 33, with an actuator needle valve 32a of the diverter actuator positioned within the diverter housing portion 33. The actuator needle valve 32a is movable linearly to open and close off an internal flow path of the diverter valve 30 which communicates with an output port 34. In some embodiments the linearly movable needle valve 32 may be replaced by a rotationally moveable valve element. A sensor housing portion 36 of the diverter valve 30 may house a sensor (e.g., pressure sensor, not shown) for monitoring a parameter (e.g., parameter), which in some embodiments is real time pressure in the internal flow path of the diverter valve 30.

Referring further to FIGS. 1 and 2, the nozzle assembly 12 may also include a nozzle valve 38 for controllably blocking the feedstock material flow into (and from) the nozzle element 22 when an interruption of flow is desired. As best shown in FIG. 2, the nozzle valve 38 may also be formed from metal, aluminum or any other suitable material, and includes an inflow port 40 which communicates with an internal feedstock material flow port 20a formed within the mixing portion 20. The nozzle valve 38 further includes an output port 42 for directing a flow of feedstock material into the nozzle 22, and an actuator housing port 44 for receiving a nozzle actuator valve 46. A sensor housing portion 48 is provided for housing a sensor (e.g., pressure, not shown). The nozzle actuator valve 46 in this example is the of the same construction as the diverter actuator 32, but it need not be of the same construction. The nozzle actuator valve 46 includes a linearly moveable needle valve 46a that communicates with an internal flow path in the nozzle valve 38 to block feedstock material from flowing through an internal flow path leading to the nozzle element 22 when the needle valve 46a is moved into a closed position. In an open position, the needle valve 46a permits feedstock material to flow elevationally down through the nozzle valve 38 into the nozzle element 22 without obstruction.

The actuator valves 32 and 46 in some embodiments are electrically actuated valves responsive to control signals from the controller 14. In some embodiments they may also be pneumatically actuated. In some embodiments the diverter valve 30 and the nozzle valve 38 may be integrated into a single valve housing disposed just upstream of the nozzle element 22, with the diverter actuator 32 and the nozzle actuator 46 arranged in separate portions of the housing as needed to operate to both divert flow and block flow as needed.

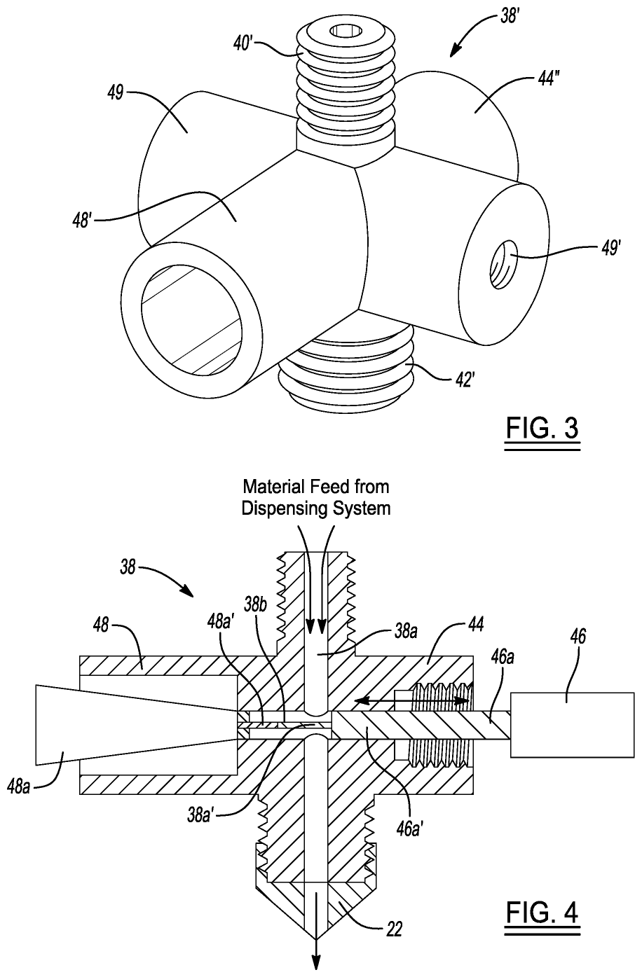

Referring to FIG. 3, a nozzle valve 38′ is shown in accordance with another embodiment of the present disclosure. The nozzle valve 38′ in this example is similar to the nozzle valve 38 of FIG. 2 and includes an inflow port 40′, an output port 42′, an actuator housing port 44′ for housing an actuator, a sensor housing portion 48′ for housing a sensor, and an additional sensor housing portion 49 for housing an additional sensor (e.g., magnet, additional pressure or flow sensors, etc.). Still another sensor port 49′ is available for using an additional sensor (or optionally for use with a control mechanism).

FIG. 4 shows internal flow passages for the nozzle valve 38. A main flow path 38a allows a straight open flow path through the nozzle valve 38 when the needle valve 46a is in the open (i.e., retracted) position. When in the fully extended orientation, a distal portion 46a′ blocks the flow at a central junction area 38a′ of the main flow path 38a. FIG. 4 also shows a sensor 48a having a probe element 48a′ disposed in a lateral flow path 38b in communication with the central junction area 38′, and thus able to sense at least one of a pressure or flow of the feedstock material through the main flow path 38a. The flow paths 38a and 38b also allow for easy cleaning and servicing of the nozzle actuator valve 46.

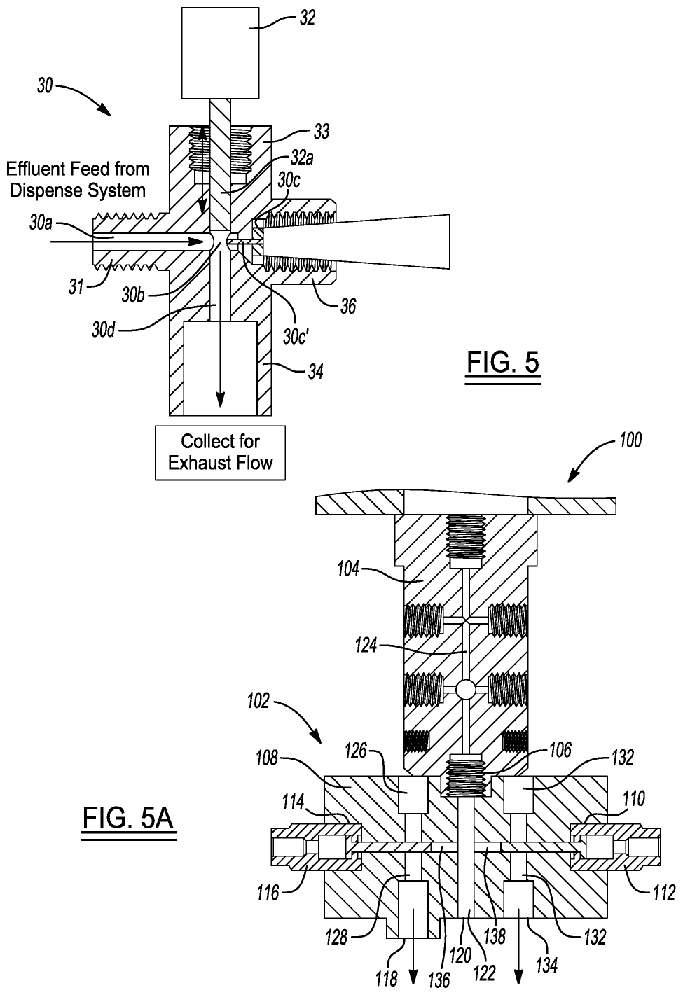

FIG. 5 shows the internal flow paths for the diverter valve 30. A main internal flow path 30a is in communication with the internal flow path 20a within the housing 20′. When the needle valve 32a is in its retracted position the feedstock flow is able to flow through the internal flow path 20a to the nozzle valve 30a. However, when the needle valve is moved into its fully extended position it enters the central junction area 30b and block off flow through the internal flow path 20 and diverts the flow through flow path 30d in the exhaust port 34. The flow leaving the exhaust flow port 34 may be collected at a separate reservoir (not shown), or possibly even routed (or pumped via a separate pump), back to the feedstock material reservoir 16 (FIG. 1). Again, the flow paths 30a and 30d, together with the central junction area 30b, enable easy cleaning and servicing of the diverter valve 30.

FIG. 5 also shows a sensor 30c positioned in the sensor housing portion 36. The sensor 30c may be any form of sensor, for example and without limitation, a pressure or flow sensor. In the embodiment shown the sensor 30c is a pressure sensor and includes a sensing probe 30c′ in communication with the central junction area 30b.

FIG. 5a shows a valve print nozzle assembly 100 in accordance with another embodiment of the present disclosure. In this example the print nozzle assembly 100 has both of the diverter valve 30 and the nozzle valve 38 of the system 10 combined into a single integrated valve system 102. The valve system 102 is secured to a distal end of a housing 104 assembly 100, in this example by a threaded connection 106. The valve system 102 includes a housing 108 having a diverter/exhaust port 110 which receives a diverter/exhaust valve 112. A nozzle port 114 receives a nozzle valve 116 for controlling flow out through a nozzle outflow port 118. The nozzle outflow port 118 may have a threaded external surface 118a for making a threaded connection to a flow nozzle (not shown) similar to the nozzle 22 of the system 10. A port 120 adjacent the nozzle outflow port 118 communicates with an internal axial flowpath 122, which in turn communicates with an axial flowpath 124 within the housing 104. An additional port 126 communicates with a flowpath 128, which in turn communicates with the nozzle outflow port 118. Similarly, an additional port 130 communicates with an internal flowpath 132 in the housing 108 and terminates in an exhaust outflow port 134. Additional internal flowpaths 136 and 138 communicate with the flowpath 122 and with flowpaths 128 and 134. During a calibration/initial setup procedure plugs (not shown) may be selectively inserted into ports 126, 132 and 122, which will be described further in the following paragraphs.

### Initial Preparation of System

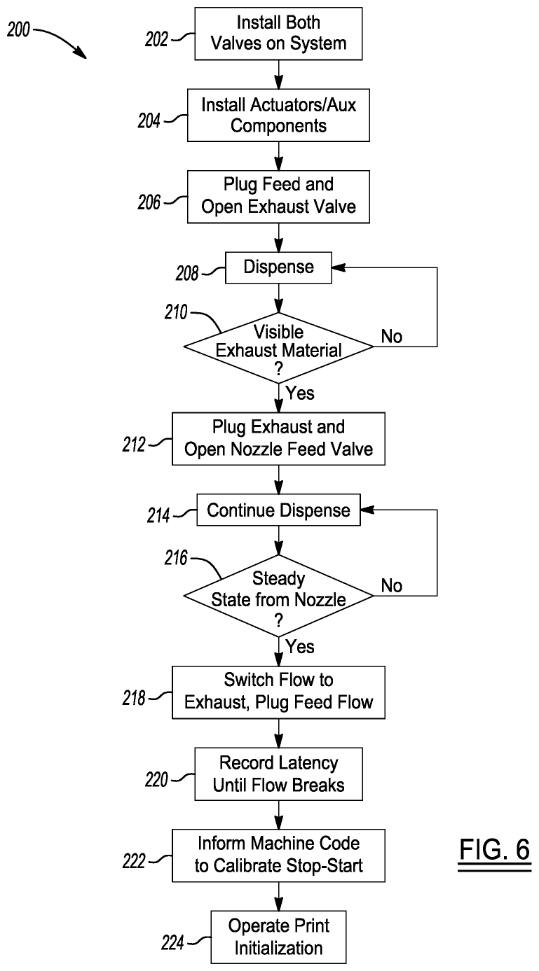

Before initially performing a printing operation using the system 10, a method of preparing the operating the nozzle system 12 will be described with reference to a flowchart 100 as shown in FIG. 6. The following method and sequence of operations is one example of how the nozzle system 12 can be initially set up to keep a steady state flow and to plan for latency during operation when the flow of feedstock material needs to be interrupted during a printing operation.

Initially both of the diverter and nozzle valves 30 and 38 should be thoroughly cleaned and then installed on the housing 20′ of the nozzle system 12, as indicated at operation 102. The actuator valves 32 and 46 may then be installed along with any other sensors (e.g., flow sensors, pressure sensors, magnets, etc.), as indicated at operation 104. Next the internal flow path 38a may be plugged (e.g., nozzle element 22 removed and a plug inserted) while the diverter actuator valve 32 is opened, as indicated at operation 106. Feedstock material may then be fed into the nozzle housing 20′, as indicated at operation 106, and a visual check made to look for feedstock material flowing out from the exhaust port 34, as indicated at operation 110. When feedstock material is visually observed flowing out from the exhaust flow part 34, then the exhaust port 34 of the diverter valve 30 may be plugged using a suitable external plug-like element while the diverter actuator is moved into its open (i.e., retracted) orientation, and the internal flow path 20′ is unplugged, as indicated at operation 112. Feedstock material is then flushed through the diverter valve 30 and through the nozzle valve 38, as indicated at operation 114. A visual check is made at operation 116 to detect when a steady state of feedstock material flow occurs out from the nozzle valve 38. Alternatively, this condition may be determined by sensor feedback either from upstream hardware or from the sensor 48a (FIG. 4) itself. When feedstock material flow is detected, then the feedstock material flow is switched through the exhaust port 34 of the diverter valve 30 while the main flow path 20′ is plugged or blocked, as indicated at operation 118. This may be accomplished, for example, at the internal flow path 38a of the nozzle valve 38. At operation 120 the latency of time interval until the flow breaks (i.e., is interrupted) is noted and recorded. This latency of time internal will be material specific, and typically may depend on various factors including, but not limited to, viscosity, yield stress, shear rate, thixotropy, etc.

Finally, the controller 14 may be programmed with the above-mentioned latency of time interval, as indicated at operation 122, to use whenever it is necessary to stop the feedstock material flow during a printing operation. This ensures that the printing operation takes into account the time needed to switch the actuator valves 30 and 38 whenever the feedstock flow is to be interrupted, and also whenever the feedstock flow is to be resumed after having been interrupted. At operation 124 a standard printing initialization process can then be started to begin a printing operation to make a part or structure.

With reference to the valve system 100 of FIG. 5a, in general, to extrude feedstock material through the nozzle 118, an actuator 116 will be retracted while keeping an actuator 112 extended. To stop the flow, the actuator 116 will extend and the actuator 112 will retract diverting the flow to an exhaust outflow port 134. During calibration the nozzle valve 116 is closed to block off flow through the nozzle outflow port 118, while the port 120 is plugged with an external plug (not shown). Ports 126 and 132 are also plugged, while the diverter/exhaust valve 112 is opened, leaving an open flowpath for the fluid through internal flowpath 122 and out through the exhaust outflow port 134. Operations 208 and 210 may then be formed. Next, nozzle flow valve 116 may be opened while the diverter/exhaust valve 112 is closed, which permits flow through flowpaths 122, 128 and out the nozzle outflow port 118. At this point operations 214 and 216 can be performed.

The present disclosure thus enables a careful, controlled interruption of flow to a print nozzle, and a carefully timed re-starting of flow after an interruption, which enables parts and structures requiring discontinuous features or portions to be manufactured, which has heretofore not been possible. The embodiments of the present disclosure can be retrofitted into extrusion printing systems in most instances with minor modifications, and does not add significant cost or complexity to the overall printing system.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. As used herein, the term “about”, when used immediately previous to a specific recited value, denotes the specific recited value as well as all values, inclusive, from +/−10% of the specific recited value.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. An apparatus for extruding material to make a part using a flowable feedstock material, the apparatus comprising:
a controller;
a print nozzle system including:
a nozzle housing for receiving the flowable feedstock material;
a nozzle element from which the flowable feedstock material is extruded; and
a valve system responsive to the controller for controllably interrupting and restarting a flow of the flowable feedstock material during a print operation.

2. The apparatus of claim 1, wherein the valve system includes a diverter valve in communication with the housing for controllably diverting at least a portion of the flow of the feedstock material to the nozzle element when the flow of the feedstock material is to be interrupted.

3. The apparatus of claim 2, wherein the diverter valve includes at least one of a needle valve movable linearly between first and second positions to selectively block flow through the diverter valve, or a rotational valve movable rotationally to selectively block flow through the diverter valve.

4. The apparatus of claim 1, wherein the valve system includes a nozzle valve in communication with the housing for controllably interrupting the flow of the feedstock material to the nozzle element.

5. The apparatus of claim 4, wherein the nozzle valve includes at least one of:
a linearly movable needle valve movable between first and second positions for controllably interrupting a flow of the feedstock material to the nozzle element; or
a rotationally movable valve movable between different rotational positions for controllably interrupting a flow of the feedstock material to the nozzle element.

6. The apparatus of claim 1, wherein the valve system includes:
a diverter valve in communication with the housing for controllably diverting at least a portion of the flow of the feedstock material to the nozzle element when the flow of the feedstock material is to be interrupted;
a nozzle valve in communication with the housing for controllably interrupting the flow of the feedstock material to the nozzle element; and
wherein the diverter valve is arranged upstream, relative to a direction of flow of the feedstock material through the housing, from the nozzle valve.

7. The apparatus of claim 6, wherein the nozzle valve is configured to communicate directly with the nozzle element.

8. The apparatus of claim 1, wherein the valve system includes:
a diverter valve in communication with the housing;
a nozzle valve in communication with the diverter valve; and
a common housing for housing both the diverter valve and the nozzle valve.

9. The apparatus of claim 1, further comprising a nozzle motion control subsystem for controlling motion of the nozzle system within at least one of:
an X axis and Y axis plane; or
a Z axis plane extending normal to the X axis and Y axis planes.

10. The apparatus of claim 1, wherein the controller is configured to apply control signals to each of the diverter valve and the nozzle valve in a desired sequence to controllably interrupt the flow of the feedstock material.

11. An apparatus for extruding material to make a part using a flowable feedstock material, the apparatus comprising:
a controller;
a print nozzle system including:
a nozzle housing for receiving the flowable feedstock material;
a nozzle element from which the flowable feedstock material is extruded;
a valve system responsive to the controller for controllably interrupting and restarting a flow of the flowable feedstock material during a print operation; the valve system including:
a diverter valve in communication with the housing for controllably diverting at least a portion of the flow of the feedstock material to the nozzle element when the flow of the feedstock material is to be interrupted; and
a nozzle valve in communication with the diverter valve and disposed downstream of the diverter valve relative to a direction of flow of the feedstock material through the nozzle system, for controllably interrupting the flow of the feedstock material to the nozzle element.

12. The system of claim 11, wherein:
the diverter valve includes at least one of a first linearly movable needle valve responsive to first control signals from the controller, or a first rotationally movable valve element responsive to the first control signals from the controller; and
the nozzle valve includes at least one of a second linearly movable needle valve responsive to second control signals from the controller, or a second rotationally movable valve element responsive to second control signals from the controller.

13. The system of claim 11, further comprising a motion control subsystem for controlling movement of the nozzle system within at least one of:
a plane defined by an X axis and a Y axis; or
along a Z axis normal to the X axis and the Y axis.

14. A print nozzle system including:
a nozzle housing for receiving a flowable feedstock material;
a nozzle element in communication with the nozzle housing from which the flowable feedstock material is extruded;
a valve system for controllably interrupting and restarting a flow of the flowable feedstock material during a print operation, and
the valve system configured relative to the nozzle housing and the nozzle element to divert a portion of the feedstock material flowing through the housing toward the nozzle element when a flow of the feedstock material is to be interrupted, and to block the flow of a remaining portion of the feedstock material upstream of the nozzle element from flowing through the nozzle element.

15. The print nozzle system of claim 14, wherein:
the valve system includes:
a diverter valve in communication with the housing for diverting the portion of the feedstock material away from the nozzle element and out from the housing; and
a nozzle valve in communication with the diverter valve and with the nozzle element, for blocking the remaining portion of the feedstock material from reaching the nozzle element.

16. The print nozzle system of claim 15, wherein:
the diverter valve includes at least one of a first linearly movable needle valve, or a first rotationally movable valve element; and
the nozzle valve includes at least one of a second linearly movable needle valve, or a second rotationally movable valve element.

17. The system of claim 15, wherein the diverter valve and the nozzle valve and configured in a common valve housing.

18. A method for extruding material to make a part using a flowable feedstock material, the method comprising:
causing a flowable feedstock material to flow into a housing and to be used to print a part on a build table;
when a flow of the feedstock material is to be temporarily interrupted, then:
using a first valve to divert at least a first portion of the feedstock material flowing through the housing out from the housing; and
using a second valve configured downstream of the first valve, relative to a direction of flow of the feedstock material through the housing, to block an additional portion of the feedstock flow from reaching a nozzle element and being extruded out from the nozzle element.

19. The method of claim 18, further comprising actuating the first valve before the second valve when the flow of the feedstock material needs to be interrupted from flowing out through the nozzle element.

20. The method of claim 18, further using a controller to control the first and second valves in a sequential manner.
